(19) United States
(12) Patent Application Publication
(10) Pub. No.: US 2005/0070389 A1
(43) Pub. Date: Mar. 31, 2005

(54) Silent chain

(75) Inventor: Kouji Morishige, Nabari City (JP)

Correspondence Address: BORGWARNER INC., POWERTRAIN TECHNICAL CENTER, 3800 AUTOMATION AVENUE, SUITE 100, AUBURN HILLS, MI, 48326-1782, US

(73) Assignee: BorgWarner Morse TEC Japan K.K., Nabari City (JP)

(21) Appl. No.: 10/935,568

(22) Filed: Sep. 7, 2004

(30) Foreign Application Priority Data
Sep. 26, 2003 (JP) 2003-334904

(51) Int. Cl. F16G 13/04

(52) U.S. Cl. 474/213; 474/212

(57) ABSTRACT

A chain comprises a plurality of inside links, guide links, and connecting pins. The inside links each have a pair of apertures, a pin aperture centerline, and teeth. The inside links are interleaved and connected into a series of rows. The guide links have a pair of apertures and a pin aperture centerline and are placed outside of outermost rows of the inside links. The connecting pins are received by the apertures and extend across the rows of the chain, connecting the inside and the guide links. At least one of the links has a central protrusion protruding in a thickness direction and the other links adjacent to the link with the central protrusion have shoulder portions that contact the protrusion. When the chain is in a back-bending state, frictional force is imparted by the central protrusion to the adjacent links with the shoulder portions, such that bending resistance occurs.

### REFERENCE TO RELATED APPLICATIONS

This application claims an invention, which was disclosed in Japanese application number 2003-334904, filed Sep. 26, 2003, entitled “SILENT CHAIN”. The benefit under 35 USC§119(a) of the Japanese application is hereby claimed, and the aforementioned application is hereby incorporated herein by reference.

The application is also related to copending continuation-in-part application Ser. No. 10/447,787, entitled “Power Transmission Chain Having Links With Lateral Spacing Elements,” filed May 29, 2003, which claims priority from continuation-in-part application Ser. No. 10/132,485, filed Apr. 25, 2002, entitled “Power Transmission Chain Having Links With Lateral Spacing Elements,” now U.S. Pat. No. 6,595,882, which is a divisional patent application of application Ser. No. 09/506,349, filed Feb. 17, 2000, entitled “Power Transmission Chain Having Links With Lateral Spacing Elements,” now U.S. Pat. No. 6,406,394, which claims benefit from provisional application No. 60/131,413 filed on Apr. 28, 1999. The aforementioned applications are hereby incorporated by reference.

### BACKGROUND OF THE INVENTION

1. Field of the Invention

The present invention relates to a silent chain, and more particularly, to an improvement of the structure of a silent chain for restraining chordal oscillation of a silent chain.

2. Description of Related Art

A silent chain is generally constructed from multiple links each having a pair of teeth and pin apertures and pivotably connected by connecting pins inserted into the pin apertures of the links.

When the engagement frequency that is determined by the number of teeth and the rotational speed of a sprocket around which a chain is wrapped coincides with resonance frequency of a chain that is determined by the length of chain span during operation and chain tension, resonance occurs in the chain span and the chain span oscillates severely in a lateral direction, thus causing noise.

In order to restrain chordal oscillation or oscillation of a chain span that causes the noise, a silent chain having a spring link interposed therein has been used.

As shown in Japanese patent application laying-open publication No. 10-54445, a spring link has a corrugation as a whole. When the spring link is assembled into a chain and between the links, the spring is compressed in a thickness direction, elastic resilience due to its compressive deformation imparts frictional force between the adjacent links. Thereby, bending resilience of the chain increases and chordal oscillation of a chain span is restrained.

However, by using such a spring link, even at the time of transmitting power by the silent chain, friction loss will always occur, thereby decreasing power transmission efficiency.

Another solution that uses spring links, projections, and a combination of the two is copending published application 2003-0236145, which is related to U.S. Pat. Nos. 6,595,882, and 6,406,394 all entitled, “Power Transmission Chain Having Links With Lateral Spacing Element.”

US 2003-0236145, U.S. Pat. No. 6,595,882, and U.S. Pat. No. 6,406,394 disclose the use of projections on a guide link. In one embodiment of the related applications, the projections are formed on an inner face of the guide links and bear upon the outermost links, maintaining a space between the main body of the guide links and the inside links. The projections are located below the guide link plate apertures. With the projections bearing on the outermost inside links, and creating the additional axial space, the sprocket width can be increased to assure full contact with all of the inside links.

In another embodiment of the related applications, the projections are formed on the outside face of the outermost inside links. The projections maintain a space between the inside links and the guide links to provide increased axial clearance.

In a third embodiment of the related applications, the guide links have two pairs of projections on an inside surface. The first pair of projections are located below the guide link plate apertures and the second pair of projections are located above the guide link plate apertures.

In a fourth embodiment of the related applications, a pair of spring links are used as spacing elements between the non-guide row of the outermost inside links and the row of outside guide links. The spring links are arranged such that the ends of the spring links are in contact with the inside links. The spring links provide an increased amount of space, allowing for a longer rocker pin that will not cause a gap, and increases the internal friction in the chain, which aids in controlling chain strand vibration.

In a fifth embodiment of the related applications, the spring links are between the non-guide row of outermost inside links and the row of outside guide links, but the ends of the spring links are in contact with the guide links.

In another embodiment of the related applications, one spring link is placed on one side of the chain between the non-guide row of inside links and the outside guide links. On the other side of the chain is an outside guide link that has a pair of projections on an inside face of the guide link. The projections are located below the guide link apertures. The combination of the spring link and the projections ensures that the rocker pin protrudes completely through the outermost non-guide row links, lending full support to the chain.

The spacing provided between the guide link and the inside links of the above embodiments of the related applications allow the rocker to make contact against the entire bearing surface of the aperture of the outermost inside link. The spacing also provides complete engagement of all of the inside links with the entire width of the sprocket.

The present invention is directed to restraining chordal oscillation of a chain span of a silent chain without decreasing power transmission efficiency.

### SUMMARY OF THE INVENTION

A chain comprises a plurality of inside links, guide links, and connecting pins. The inside links each have a pair of apertures, a pin aperture centerline, and teeth. The inside links are interleaved and connected into a series of rows. The guide links have a pair of apertures and a pin aperture centerline and are placed outside of outermost rows of the inside links. The connecting pins are received by the apertures and extend across the rows of the chain, connecting the inside links and the guide links. At least one of the links has a central protrusion protruding in a thickness direction and the other links adjacent to the link with the central protrusion have shoulder portions that contact the protrusion. When the chain is in a back-bending state, frictional force is imparted by the central protrusion to the adjacent links with the shoulder portions, such that bending resistance occurs.

### BRIEF DESCRIPTION OF THE DRAWING

FIG. 1(a) is a front elevational view of a portion of a silent chain according to a first embodiment of the present invention. FIG. 1(b) is a top plan view of a portion of the silent chain of FIG. 1(a).

FIG. 2(a) is a front elevational view of a portion of a silent chain of FIG. 1 during bending motion in the engaging direction. FIG. 2(b) is a top plan view of a portion of the silent chain of FIG. 2(a).

FIG. 3(a) is a front elevational view of a portion of a silent chain of FIG. 1 during back bending. FIG. 3(b) is a top plan view of a portion of the silent chain of FIG. 3(a).

FIG. 4(a) is a front elevational view of a portion of a silent chain according to a second embodiment of the present invention. FIG. 4(b) is a top plan view of a portion of the silent chain of FIG. 4(a).

FIG. 5(a) is a front elevational view of a portion of a silent chain of FIG. 4 during bending motion in the engaging direction. FIG. 5(b) is a top plan view of a portion of the silent chain of FIG. 5(a).

FIG. 6(a) is a front elevational view of a portion of a silent chain of FIG. 4 during back bending. FIG. 6(b) is a top plan view of a portion of the silent chain of FIG. 6(a).

FIG. 7(a) is a front elevational view of a portion of a silent chain according to a third embodiment of the present invention during back bending. FIG. 7(b) is a top plan view of a portion of the silent chain of FIG. 7(a).

FIG. 8(a) is a front elevational view of a portion of a silent chain according to a fourth embodiment of the present invention during back bending. FIG. 8(b) is a top plan view of a portion of the silent chain of FIG. 8(a).

### DETAILED DESCRIPTION OF THE INVENTION

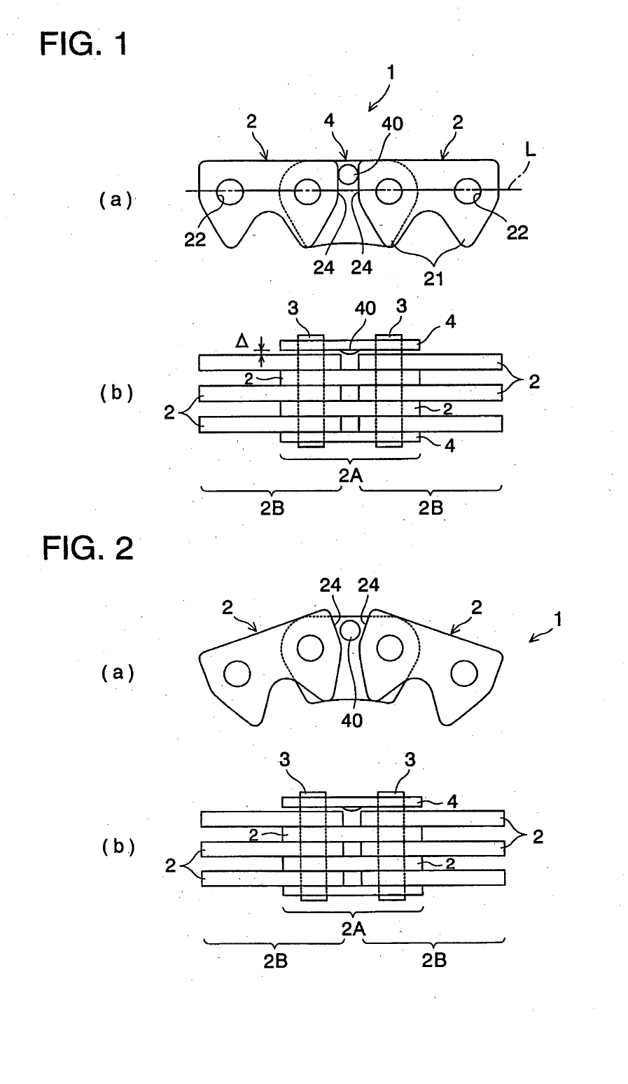

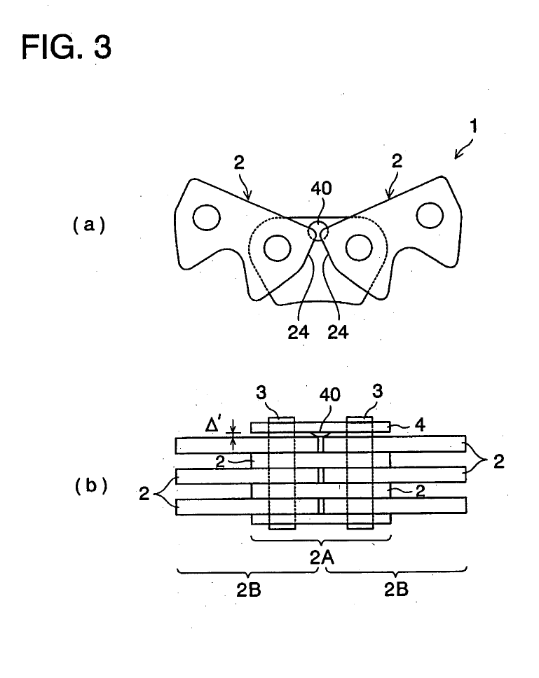

FIGS. 1 to 3 show a first embodiment of the present invention. FIG. 1 shows a linearly extended state of a silent chain, FIG. 2 shows an engaging bending state of the chain with the sprocket (not shown). FIG. 3 shows a back-bending state of the chain. Only three links adjacent to each other along the length of the chain are shown in these drawings for clarity.

As shown in FIG. 1, a silent chain 1 is constructed from a plurality of interleaved inside links 2 each having a pair of teeth 21 engageable with a sprocket and pin apertures 22, which are pivotably connected to each other by connecting pins 3 inserted into the pin apertures 22. Guide links 4, which do not have any teeth, are disposed outside the outermost inside links 2 and maintain the chain 1 in place on the sprocket. The ends of the connecting pins 3 are fixedly attached to the pin apertures of the guide links 4.

The silent chain 1 comprises a guide row 2A formed of inside links 2 disposed at the same longitudinal position as the guide link 4 and a link row or a non-guide row 2B disposed between the longitudinally adjacent guide rows 2A.

The guide link 4 has a protrusion 40 formed thereon, which protrudes in a thickness direction. The protrusion 40 is located at a longitudinally central position and above the pin aperture centerline L. The shape of the end surface of the protrusion 40 is spherical. In addition, the end surface of the protrusion 40 may be tapered toward the distal end. The protrusion 40 may be formed by the compressive process in which a punch presses the surface opposite the protrusion. In this case, additional parts are not required thereby simplifying the assembly process.

The inside link 2 disposed adjacent to the guide link 4 in a thickness direction has a pair of shoulder portions 24 on opposite sides. Each of the shoulder portions 24 has a flat upraised portion extending perpendicular to the pin aperture centerline L.

A clearance Δ is formed between the guide link 4 with the protrusion 40 and the adjacent outermost inside link 2 of the link row 2B. This clearance Δ is suitably determined in accordance with the height of the protrusion 40 and the size of the shoulder portion 24, but it is not necessarily required.

During operation, the silent chain 1 bends toward the engaging direction from the linearly extended state shown in FIG. 1. Each link row 2A, 2B rotates or articulates around the connecting pin 3 as shown in FIG. 2. Then, each shoulder portion 24 of the inside links 2 forming the link rows 2B does not interfere with the protrusion 40 of the outside link 4, allowing a smooth articulation of the inside links 2 on the engaging side. Therefore, bending resistance will not be increased during engagement with the sprocket and there is no decrease in power transmission efficiency.

On the other hand, as the silent chain 1 back-bends toward the back side of the chain and away from the sprocket from the linearly extended state shown in FIG. 1, each link row 2A, 2B rotates or articulates around the connecting pin 3 in the direction opposite the engaging direction, as shown in FIG. 3. Each shoulder portion 24 of the inside links 2 forming the link rows 2B interferes with the protrusion 40 of the outside link 4 and rides onto the protrusion 40.

The clearance between the guide link 4 and the inside link 2 adjacent to the guide link 4 changes from Δ to Δ′ (>Δ). Thereby, compressive force is applied between the adjacent inside links 2 in a thickness direction, causing frictional force between the adjacent inside links 2. As a result, bending resistance on the back side of the chain is increased and back-bending motion of the chain is restrained, thus restraining chordal oscillation.

In this case, since the shoulder portion 24 of the inside link 2 rides onto the protrusion 40 of the guide link 4 to cause bending resistance only at the time of back-bending of the chain, chordal oscillation can be restrained without decreasing power transmission efficiency.

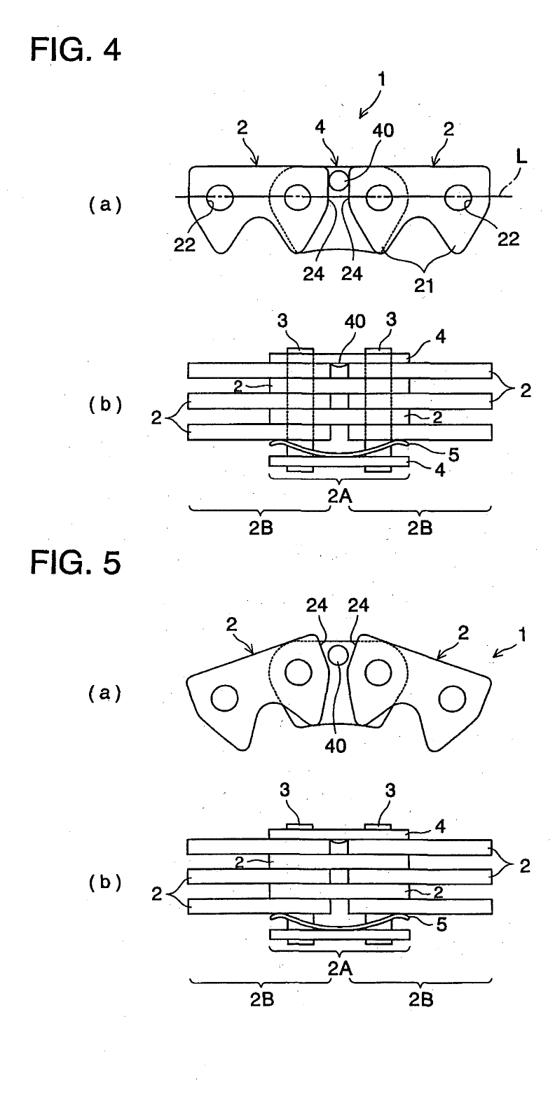

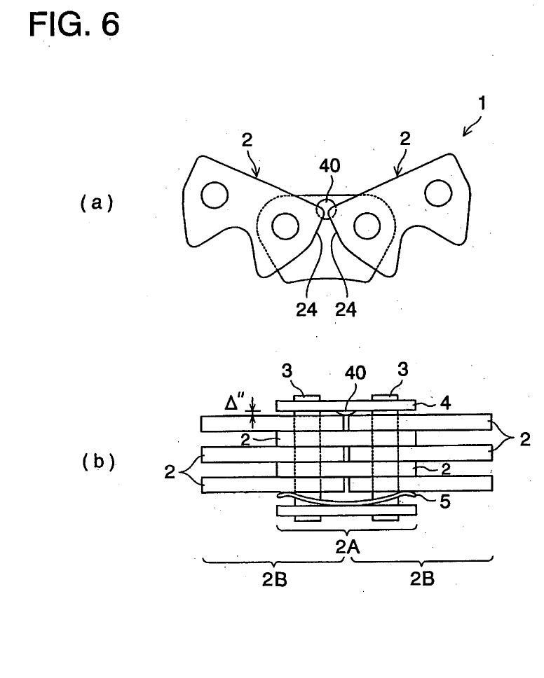

FIGS. 4 to 6 show a second embodiment of the present invention. FIG. 4 shows a linearly extended state of a silent chain, FIG. 5 shows an engaging bending state of the chain with the sprocket. FIG. 6 shows a back-bending state of the chain. Only three links adjacent to each other along the length of the chain are shown in these drawings for clarity.

This second embodiment differs from the first embodiment in that a spring link 5 is provided between the guide link 4 and the adjacent outermost inside link 2 of the link row 2B. The spring link 5 is provided with zero or slight deflection when it is assembled into the chain 1.

At zero deflection of the spring link 5, compressive force is not applied between the adjacent inside links 2 of the link rows 2A, 2B and frictional force is not imparted between the adjacent inside links 2. At slight deflection of the spring link 5, a small compressive force is applied between the adjacent inside links 2 and small frictional force is imparted between the adjacent inside links 2. In this case, frictional force to be applied between the adjacent inside links 2 can be determined at a far smaller value than the frictional force supplied by the prior art spring link. That is because the increment of the frictional force caused by riding of the shoulder portion 24 of the inside link 2 onto the protrusion 40 of the guide link 4 can be expected.

During operation, as the silent chain 1 bends toward the engaging direction from the linearly extended state shown in FIG. 4, each link row 2A, 2B rotates or articulates around the connecting pin 3 as shown in FIG. 5. Each shoulder portion 24 of the inside links 2 forming the link rows 2B does not interfere with the protrusion 40 of the outside link 4, allowing a smooth articulation of the inside links 2 on the engaging side. Therefore, bending resistance will not be increased during engagement with the sprocket and there is no decrease in power transmission efficiency.

On the other hand, as the silent chain 1 back-bends toward the back side of the chain and away from the sprocket, from the linearly extended state shown in FIG. 4, each link row 2A, 2B rotates or articulates around the connecting pin 3 in the direction opposite the engaging direction, as shown in FIG. 6. Each shoulder portion 24 of the inside links 2 forming the link rows 2B interferes with the protrusion 40 of the outside link 4 and rides onto the protrusion 40.

The clearance Δ″ occurs between the guide link 4 and the adjacent outermost inside link 2. Thereby, compressive force is applied between the adjacent inside links 2 in a thickness direction, causing frictional force between the adjacent inside links 2. At the same time, the outermost inside link 2 deforms the spring link 5 between the guide link 4 and the outermost inside link 2. Elastic resilience due to elastic deformation of the spring link 5 applies compressive force between the adjacent inside links 2 to cause frictional force between the adjacent inside links 2. In such a manner, bending resistance on the back side of the chain is further increased and back-bending motion of the chain is further restrained, thus restraining chordal oscillation.

In this case, since the shoulder portion 24 of the inside link 2 rides onto the protrusion 40 of the guide link 4 to cause bending resistance only at the time of back-bending of the chain, chordal oscillation can be restrained without decreasing power transmission efficiency.

In the first and second embodiments, a protrusion is provided on a guide link, but the present invention is not limited to these embodiments. The inside link may have a protrusion.

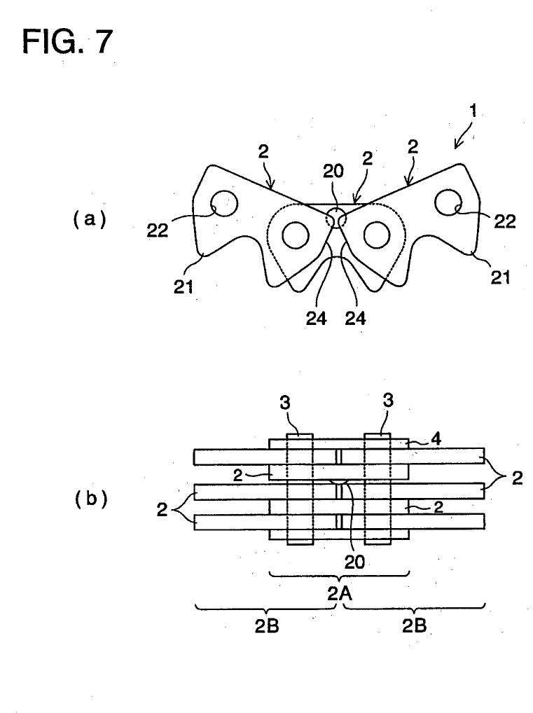

FIG. 7 shows a third embodiment in which an inside link has the protrusion. As shown in FIG. 7, the inside link 2 of the guide row 2A has a protrusion 20 formed thereon. The protrusion 20 is located centrally in a longitudinal direction and above the pin aperture centerline. The end surface of the protrusion 20 is spherical or tapered toward the distal end. The protrusion 20 may be formed by the compressive process in which a punch is pressed on the surface opposite the protrusion 20.

Similar to the first embodiment, in this case during engaging bending of the chain, the shoulder portion 24 of the inside link 2 does not interfere with the protrusion 20, thereby achieving a smooth engaging bending motion of the chain. On the other hand, during back-bending of the chain, the shoulder portion 24 of the inside link 2 interferes with and rides onto the protrusion 20, thereby applying compressive force between the adjacent inside links 2, between the inside link 2, and the guide link 4, causing frictional force between the links. Bending resistance of the chain is thus increased and chordal oscillation of the chain span can be restrained.

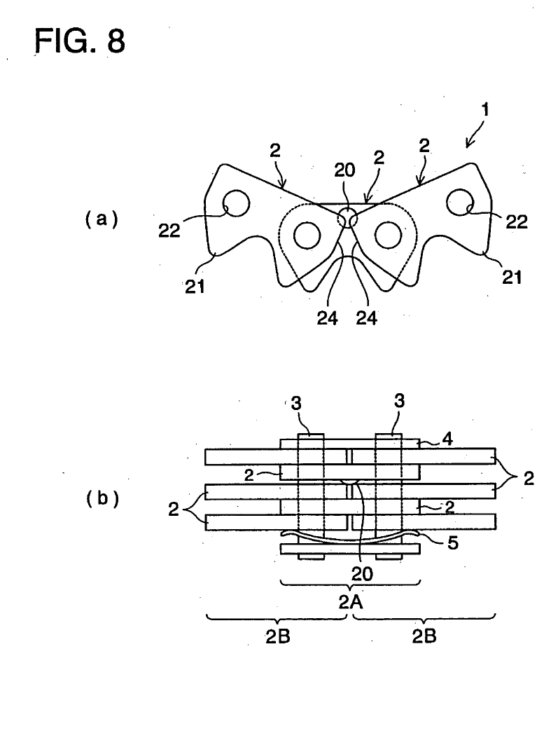

FIG. 8 shows a fourth embodiment of the present invention. In this embodiment, the inside link 2 has a protrusion 20 formed thereon and a spring link 5 is provided between the guide link 4 and the adjacent outermost inside link 2. The spring link 5 is provided at zero or slight deflection when assembled into the chain.

Similar to the first embodiment, in this case during engaging bending of the chain, the shoulder portion 24 of the inside link 2 does not interfere with the protrusion 20, thereby achieving a smooth engaging bending motion of the chain. On the other hand, during back-bending of the chain, the shoulder portion 24 of the inside link 2 interferes with and rides onto the protrusion 20, thereby applying compressive force between the adjacent inside links 2, between the inside link 2, and the guide link 4, causing frictional force between the links. Bending resistance of the chain is thus increased and chordal oscillation of the chain span can be restrained.

In the first embodiment, a protrusion 40 is formed on one guide link 4 of the guide row 2A, but the protrusion 40 may be formed on both guide links 4 of the guide row 2A. Also, a guide link 4 may be centrally disposed in the guide row 2A.

In the second and fourth embodiment, the spring link 5 adjoins the guide link 4, but the spring link 5 may be disposed between the adjacent inside links 2 in the guide row 2A. Alternatively, the spring link 5 may be disposed in the link row 2B.

In the third embodiment, only one inside link 2 having a protrusion 20 is provided in the guide row 2A, but a plurality of inside links 2 each having a protrusion may be provided in the guide row 2A.

By combining the first embodiment with the third embodiment, an inside link and an outside link both having a protrusion may be provided in one silent chain. Also, by combining the second embodiment with the fourth embodiment, an inside link and an outside link both having a protrusion and a spring link may be provided in one silent chain.

A guide row or link row formed of a link with a protrusion and a guide row or link row formed of a link without a protrusion may be arranged at a random pattern along the length of the chain.

In this case, back-bending motion of the link is prevented at a portion where a protrusion is provided, whereas back-bending motion of the link is not prevented at a portion where a protrusion is not provided. Also, a portion where a protrusion is provided functions as a node of chordal oscillation of a silent chain. In this case, such nodes are disposed at a random pattern along the length of a chain.

Therefore, in operation, the length of a chord or a chain span between the adjacent nodes varies aperiodically between the drive and driven sprockets. Thereby, resonance will not occur in the silent chain at any revolution or tension in the chain.

Those skilled in the art to which the invention pertains may make modifications and other embodiments employing the principles of this invention without departing from its spirit or essential characteristics particularly upon considering the foregoing teachings. The described embodiments and examples are to be considered in all respects only as illustrative and not restrictive. The scope of the invention is, therefore, indicated by the appended claims rather than by the foregoing description. Consequently, while the invention has been described with reference to particular embodiments and examples, modifications of structure, sequence, materials and the like would be apparent to those skilled in the art, yet fall within the scope of the invention.

1. A silent chain for restraining chordal oscillation comprising:
a) a plurality of interleaved inside links, each of the inside links having a pair of apertures, a pin aperture centerline, and teeth, the inside links being interleaved and connected into a series of rows;
b) a plurality of guide links, each of the guide links having a pair of apertures and a pin aperture centerline, the guide links being placed outside of outermost rows of the inside links to form guide rows; and
c) connecting pins received by the apertures, the connecting pins extending across the rows of the chain, connecting the inside links and the guide links;
wherein at least one of the inside links or the guide links have a central protrusion protruding in a thickness direction and wherein the other inside links or guide links adjacent to the link with the central protrusion have shoulder portions that contact the central protrusion; and
wherein when the chain is in a back-bending state, frictional force is imparted by the central protrusion to the adjacent links with the shoulder portions, such that bending resistance occurs.

2. The silent chain of claim 1, wherein the link with the central protrusion is an inside link.

3. The silent chain of claim 1, wherein the link with the central protrusion is a guide link.

4. The silent chain of claim 1, wherein the protrusion is located above the pin aperture centerline of the link.

5. The silent chain of claim 1, wherein the protrusion has a spherical or tapered end surface.

6. The silent chain of claim 1, wherein the protrusion is formed by a compressive process.

7. The silent chain of claim 1, wherein the shoulder portion has a flat upraised portion extending perpendicular to the pin aperture centerline of the link.

8. The silent chain of claim 1, wherein the plurality of links are arranged at a random pattern along the length of the chain.

9. The silent chain of claim 1, further comprising a spring link that elastically deforms due to compressive force.

10. The silent chain of claim 9, wherein the spring link is located between the guide links and adjacent outermost inside links.

11. The silent chain of claim 1, wherein the central protrusion provides a clearance between the link having the protrusion and an outermost adjacent link to the protrusion.
